(19) United States
(12) Patent Application Publication
(10) Pub. No.: US 2002/0111817 A1
(43) Pub. Date: Aug. 15, 2002

(54) Network-based system and method for facilitating conception of inventions in a directed manner

(76) Inventor: John E. Cronin, (US)

Correspondence Address: ip Capital Group, Inc., Attn: Ryan K. Simmons, 400 Cornerstone Drive, Suite 325, Williston, VT, 05495, US

(21) Appl. No.: 09/781,368

(22) Filed: Feb. 12, 2001

Related U.S. Application Data
(60) Provisional application No. 60/181,459, filed on Feb. 10, 2000.
(60) Provisional application No. 60/181,816, filed on Feb. 11, 2000.
(60) Provisional application No. 60/181,741, filed on Feb. 11, 2000.
(60) Provisional application No. 60/179,675, filed on Feb. 2, 2000.

(51) Int. Cl. G06F 17/60; G06F 15/16

(52) U.S. Cl. 705/1; 709/204

(57) ABSTRACT

In general, in one aspect, the invention features a system for facilitating conception of inventions in a directed manner. The system preferably includes a computer processor programmed to execute one or more of the following; requesting and accepting data input; aggregating and storing the input data; and providing output displaying the aggregated input data. The input data may include the following: mess statements; data statements relating to the mess statements; problem statements relating to the data statements; elements relating to the problem statements, mess statements and/or data statements; solutions to the problem statements; limitations of problem-element-solution combinations; and solutions to the limitations.

### 1. CROSS REFERENCE TO RELATED CO-PENDING APPLICATIONS

This application claims the benefit of, and expressly incorporates herein by reference, the entire disclosures of the following U.S. patent applications:

U.S. patent application Ser. No. ______ (ipCG-507), entitled SYSTEM AND METHOD FOR FACILITATING THE CONCEPTION OF INVENTIONS IN A DIRECTED MANNER, filed Feb. 12, 2001, which in turn claims priority to U.S. patent application Ser. No. 60/181,459, entitled PROCESS FOR FACILITATING THE CONCEPTION OF INVENTIONS IN A DIRECTED MANNER, filed Feb. 10, 2000;

U.S. patent application Ser. No. ______ (ipCG-508), entitled NETWORK BASED SYSTEM AND METHOD FOR FACILITATING THE CONCEPTION OF INVENTIONS IN A DIRECTED MANNER, filed Feb. 12, 2001, which in turn claims priority to U.S. patent application Ser. No. 60/181,816, entitled WEB-BASED PROCESS FOR FACILITATING THE CONCEPTION OF INVENTIONS IN A DIRECTED MANNER, filed Feb. 11, 2000;

U.S. patent application Ser. No. ______ (ipCG-509), entitled INVENTION INTERVIEW PROCESS, filed Feb. 12, 2001, which in turn claims priority to U.S. patent application Ser. No. 60/181,741, entitled INVENTION INTERVIEW PROCESS, filed Feb. 11, 2000;

U.S. patent application Ser. No. ______ (ipCG-519), entitled AUTOMATED IP TRACKING SYSTEM AND METHOD, filed Feb. 12, 2001, which in turn claims priority to U.S. patent application Ser. No. 60/181,741, entitled AUTOMATED IP PROCESS FOR TRACKING IP MATTERS, filed Feb. 11, 2000;

U.S. patent application Ser. No. ______ (ipCG-506), entitled SCANNING INVENTION PROCESS, filed on Jan. 19, 2001, which in turn claims priority to U.S. patent application Ser. No. 60/179,675, entitled SCANNING INVENTION PROCESS, filed Jan. 19,2001.

### 2. FIELD OF THE INVENTION

The invention provides a novel method for directly facilitating conception by one or more persons of one or more potentially patentable inventions in a targeted area, such as a specific technology field or market space.

### 3. BACKGROUND OF THE INVENTION

Art relating to the background of the invention is discussed in the ensuing subsections:

### 3.1 Invention as a Creative Process

The degree of inventiveness displayed by humans is one of the primary characteristics distinguishing humans from other animals. The earliest human archeological sites are characterized by the presence of tools invented by humans. The advent of recorded history is the direct result of human invention, and that history is largely a history of human invention, as seen in the advance of science and technology and corresponding changes in human social, organizational and political structures. Today, the inventive process is the source of an unprecedented pace of technological development, a unique trait of the ever-changing modern world.

Given the historical and cultural importance of invention, many researchers have investigated the mental processes associated with inventing. For example, Colangelo et al. investigated mechanical inventiveness (i.e., the conception and development of new devices which require use of mechanical principles) to identify psychological characteristics shared by successful inventors (Ciba Identified. Symp. 1993, 178:160-70). Other researchers have focused on the creative aspects of groups. Still others have investigated the effects of social or organizational structures on inventiveness. Lamoreaux et al., for example, investigated the effects of economic changes on the rate of invention and concluded that high rates of inventive activity encourage the evolution of a market for technology, which in turn encourages greater specialization and inventive productivity as individuals find it increasingly feasible to sell and license their discoveries (Proc Natl Acad Sci U.S.A. 1996; 93(23):12686-92).

### 3.2 Inventions as Legal Property

Most countries of the world have established legal schemes to govern the patenting of inventions. Patent laws are typically administered by a centralized patent office, and only licensed patent attorneys and/or agents are legally permitted to represent others before such office.

In the United States, the patent system is based on Article I of the U.S. Constitution and consists an enormous body of statutory law, case law, regulations and procedures, administered by the U.S. Patent and Trademark Office (USPTO). Although individual inventors may represent themselves before the USPTO, only registered patent attorneys and patent agents may represent others. Patent attorneys and agents must qualify for registration by passing a federally administered exam. The exam requires prospective patent attorneys and agents to demonstrate a detailed knowledge of patent law and procedure. However, while patent attorneys and agents are experts in patent law, they typically have no formal training in the art of inventing or in techniques for working with inventors or others to facilitate invention.

### 3.3 Software for Use in Preparing Patent Applications

Software tools are available for assisting attorneys and inventors to prepare patent applications. For example, the PatentProTM software system is stated to “walk the user through the patent application process with ease and at a fraction of the cost of hiring a patent attorney.” See www.4patpro.com/press041300.htm. The software is asserted to produce a properly formatted patent application suitable for submision to the PTO. However, there is no presently available software system with the capability of facilitating the conception of inventions.

### 3.4 Methods for Developing Inventions

Inventions are commonly perceived to be the result of highly creative cognitive processes achievable by only a few unusually talented individuals. Furthermore, it is commonly believed that only those with extensive training in certain highly technical fields have the necessary background for inventing. At an organizational level, these misconceptions can result in inefficient use of intellectual resources.

Numerous methods are known for enhancing or stimulating creativity. Examples include brainstorming, the Theory of Inventive Problem Solving method (TRIZ), and creative problem solving. Of these methods, only TRIZ specifically relates to facilitating invention of potentially patentable ideas. Developed in Russia, TRIZ (the acronym is based on the Cyrillic spelling) focuses on the methodological resolution of contradictions through the application of innovative solutions.

None of the presently used methods for facilitating creativity even attempts to employ a predefined set of rules to facilitate conception by one or more persons of one or more completely new inventions within targeted technology fields or market spaces.

There is a need in the art for a software-based method of facilitating invention, which permits an organization to fully benefit from the inventive capacity of its intellectual resources, including its employees, outside contractors, and others associated with the organization. The method should result in the generation of multiple inventions and should facilitate the conception of inventions in targeted areas, such as targeted market areas or targeted technology areas. Moreover, the method should facilitate assessment of the inventions by the organization in a manner which helps to ensure (1) that the organization's financial resources are wisely invested in the most promising of the inventions thus conceived; and (2) that cost-effective business decisions can be made regarding which inventions should be selected for the costly investment required for patent prosecution.

### 4. SUMMARY OF THE INVENTION

The invention relates to a system for facilitating conception of inventions in a directed manner preferably including a computer processor programmed to execute one or more of the following; requesting and accepting data input; aggregating and storing the input data; and providing output displaying the aggregated input data. The input data may include the following: mess statements; data statements relating to the mess statements; problem statements relating to the data statements; elements relating to the problem statements, mess statements and/or data statements; solutions to the problem statements; limitations of problem-element-solution combinations; and solutions to the limitations.

The input data may include one or more mess statements. The input data may include one or more data statements relating to the mess statements. The input data may include one or more problem statements relating to the data statements, elements and/or mess statements. The input data may include one or more elements relating to the problem statements, mess statements and/or data statements, or the elements may be randomly generated or conceived by the users as the result of a stimulus. The elements may be conceived using a visual, tactile or olfactory stimulus. The input data may include one or more solutions to the problem statements. The one or more of the solutions may be conceived using one element and a problem statement as creative stimulus, and the solution may be stored in a manner which indicates its relationship to a problem and an element. The input data may include one or more limitations of problem-element-solution combinations. The input data may include one or more solutions to the limitations. The system may instruct the user that a complete invention includes the following: a seed of an invention; all limitations of the seed of an invention; and all solutions to the limitations.

The computer processor may be a component of a server. The system may further include one or more participant computers operably linked to the server. The participant computer(s) may be linked via a network system selected from the following; local area networks, virtual private networks, an near private networks, the Internet, and an intranet. The participant computers may be remotely located relative to the server; and/or one or more of the participant computers may be remotely located relative to one or more other participant computers.

In general, in another aspect, the invention features a method for facilitating conception of inventions in a directed manner preferably including the following. First, providing a computer processor programmed to accept input and provide output. Second, inputting data selected from the following group: mess statements; data statements relating to the mess statements; problem statements relating to the data statements; elements relating to the problem statements, mess statements and/or data statements; solutions to the problem statements; limitations of problem-element-solution combinations; and solutions to the limitations. Second, aggregating and storing the data inputted. Third, providing output displaying the aggregated inputted data.

The method may further include facilitating the conception by one or more participants of any one or more types of information from the following group: mess statements; data statements relating to the mess statements; problem statements relating to the data statements; elements relating to the problem statements, mess statements and/or data statements; solutions to the problem statements; limitations of problem-element-solution combinations; and solutions to the limitations. The method may further include using a problem statement and an element as creative stimuli to facilitate conception of a solution to the problem statement. The method may further include identifying on or more limitations of a problem-element-solution combination and solutions to the limitation. The problem-element combinations may be used as creative stimuli to facilitate inventive conception. The method may further include communicating via a telephone system, the telephone system having conference calling capabilities.

### 5. DEFINITIONS

As used herein, the term “invention” means conceptual subject matter pertaining to (1) a useful product or process not previously known to the person(s) conceiving of the invention; or (2) a new use for an existing product or process, which use was not previously known to the person(s) conceiving of the invention. The term “invention” includes both patentable and non-patentable subject matter. It is noted that patentability is based on legal standards, which vary with changes in law; furthermore, patentability is premised on a legal analysis of the precise words of a patent claim and not on the degree of novelty of an inventive concept in general. The term “inventor,” is used herein to refer to one who has solely or jointly conceived of an invention.

Unless specifically indicated, legal terms of art used herein (e.g., product, process, novel, nonobvious, inventive step, utility, enable and the like) should be understood in their broadest sense, as encompassing not only strict legal definitions, but also encompassing ordinary meaning that would be attributed to such terms by one with no specialized knowledge of patent law.

### 6. BRIEF DESCRIPTION OF THE DRAWINGS

FIG. 1 schematically illustrates one aspect of the practice of the network-based IOD™ system of the invention.

FIG. 2 is a flow chart diagram showing the steps involved in practicing one embodiment of the network-based IOD™ of the invention.

FIG. 3 shows an illustrative login user interface screen for use in a network-based IOD™ session.

FIG. 4 shows an illustrative user interface screen for entering a user name in a network-based IOD™ session.

FIG. 5 shows an illustrative user interface screen used for inputting a WIBNI statement for use in a network-based IOD™ session.

FIG. 6 shows an illustrative user interface screen used for voting on a preferred WIBNI statement for use in a network-based IOD™ session.

FIG. 7 shows an illustrative user interface screen for use in entering data statements in a network-based IOD™ session.

FIG. 8 shows an illustrative user interface screen for use in entering problem statements in a network-based IOD™ session.

FIG. 9 shows an illustrative user interface screen for use in entering elements in a network-based IOD™ session.

FIG. 10 shows an illustrative user interface screen for use in facilitating conception of seed inventions in a network-based IOD™ session.

FIG. 11 shows an illustrative user interface screen for use in facilitating conception of enabling concepts in a network-based IOD™ session.

FIG. 12 shows an illustrative invention tree generated by one embodiment for use in a network-based IOD™ session.

### 7. DETAILED DESCRIPTION OF THE INVENTION

The invention provides a system and method for facilitating conception of inventions. The method is referred to herein as an Invention on Demand® (IOD™) session. The system is preferably a network-based system. The use of a network-based system facilitates network-mediated interaction by participants. The use of a network-based system also improves the ease of aggregating and documenting conceptual and other information generated by the IOD™ process, whether the participants are located in the same room or at distant locations around the world.

The process requires at least one participant. In a simple system, the invention involves a single participant using a computer programmed to execute the IOD™ method of the invention. However, in the preferred embodiment, the method involves multiple participants, interacting via a network. Additionally, the process preferably involves at least one facilitator, who is trained in the IOD™ method of the invention and in the use of the IOD™ system of the invention. However, it will be appreciated that the computer can play the role of facilitator, and consequently, that the involvement of a human facilitator is not strictly necessary. Moreover, it should also be noted that one or more persons can play both the role of participant and the role of facilitator. The participant(s) and facilitator(s) may be located in a common location, such as a conference room, or in separate locations, such as different rooms, buildings, or geographical regions.

The IOD™ method employs creativity tools to stimulate inventive processes that are native to each participant in the IOD™ session. Participants in an IOD™ session can be any combination of individuals with sufficient technical, business, or consumer knowledge, or other kinds knowledge, sufficient to permit the individuals to contribute to the inventive process. Preferably, the participants include individuals with technical knowledge to contribute to solving a technical problem in a specific technical area. The knowledge level of participants will vary depending on the nature of the technical area, ranging from ordinary consumers for invention of simple consumer products of minimal complexity to highly trained specialists, for technical invention in fields such as electrical engineering, chemistry or biotechnology. Moreover, a single IOD™ session may involve participants with a variety of technical and/or non-technical skill sets. For example, a session may involve a combination of chemical, biological, electrical, and other experts where the IOD™ session is targeting inventions in which susch technical areas converge (e.g., DNA chip technology, high throughput drug screening technology, nanotechnology, etc.). As another example, it may be useful to combine business experts and/or consumers (who can provide problems or desires) with technical experts (who can provide technical solutions addressing the problems or desires).

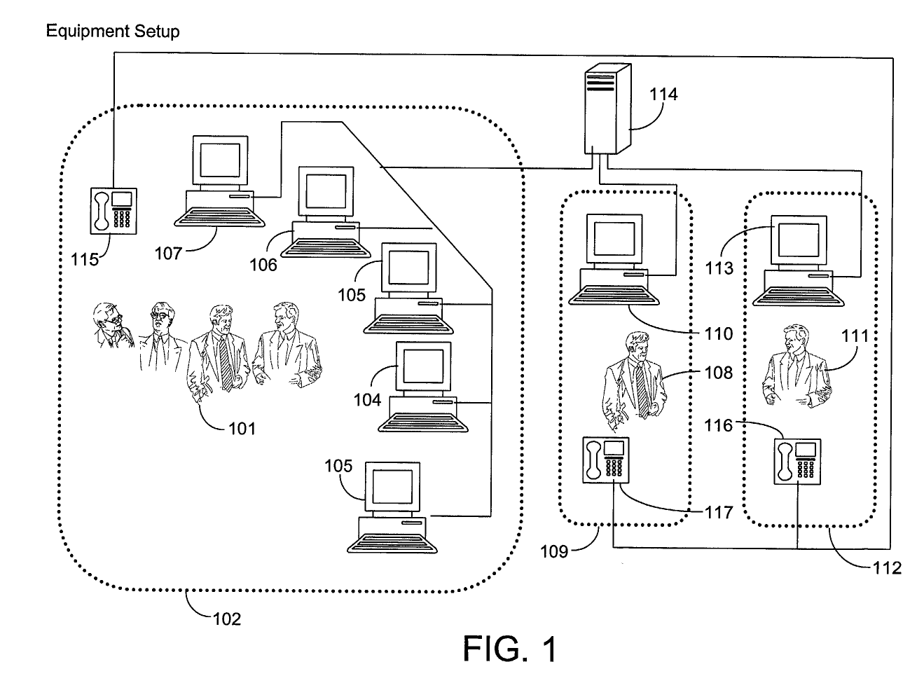

FIG. 1 exemplifies one embodiment of a network-based IOD™ system of the invention. One or more users 101 at site 102 using computers 103-107 electronically interact with remote user 108 at site 109 using computer 110 and remote user 111 at site 112 using computer 113. Computers 103-107, 110 and 113 are preferably linked via a network to server 114. One or more of the users at sites 102, 109 and 112 may play the role of facilitator or facilitator/participant. The remaining users play the role of participants. Alternatively, there may be no human facilitator, in which case the system is programmed to facilitate the IOD™ session.

Communication through the computer network may involve textual communication, verbal communication and/or visual communication. The system may operate over a variety of known network types such as LAN (Local Area Network), a VPN (Virtual Private Network), an NPN (Near Private Network), the Internet, an intranet, or other network. The basic computer network may be supplemented by a separate telecommunications network, e.g., to enable telephonic or other kinds of verbal and/or visual communication among the participant(s) and facilitator(s). In FIG. 1, this concept is illustrated by telephones 115, 116 and 117 electronically linked by a telecommunications network. In a preferred aspect, verbal communication is accomplished via the internet.

The computers 103-107, 110 and 113 are equipped with an interface. Where the system is internet-based or intranet-based, the interface may be a simple web browser (e.g., Netscape™, Explore™, etc.), and the system may be programmed to operate in a website-type format. Alternatively, the computers 103-107, 110 and 113 may be equipped with a specialized interface designed to permit input and/or provide output, as discussed more fully below.

The server(s) 114 of the invention are preferably programmed to facilitate input of data from remote users, to aggregate and store the data, and to provide output to the users, either on their individual computers, or at a central location. For example, in one aspect of the invention, where all users are in a single location, computers 103-107, 110 and 113 permit input, and the input from the users is aggregated and displayed on a central display (not shown) viewable to the users as output. This arrangement facilitates group participation, especially in a single room.

It will be appreciated that various programming languages are known in the art and may be employed in the practice of the invention. Examples include VBSCRIPT, JAVASCRIPT, and SEQUEL.

The user interface computers 103-107, 110 and 113 are preferably equipped with standard input devices, such as a keyboard and a screen-pointing device such as a mouse. Other input devices may also be used, such as pen-based input devices, touch screens, etc. For access to the Internet, the user interface computers 103-107, 110 and 113 may have a modem, DSL connection or other means for accessing the Internet. A computer with 32 MB of RAM, and a central processor with a clock speed of 133 MHz or greater is preferred. The Internet connection preferably has a speed of at least 58.8 bits per second data rate.

In addition to facilitator(s) and participant(s), described above, another user of the system can be one or more persons, or representatives of an entity, with a proprietary interest in inventions generated by the IOD™ method, e.g., the assignee or licensee, or a representative of the assignee or licensee, of such inventions. Such person(s) can be designated the “owner(s)” of the session. The role of the owner(s) is to ensure that the nature of the inventions being created is consistent with the intellectual property strategy of the owner(s) or the entity or entities represented by the owner(s).

### 7.1 The IOD™ System and Method

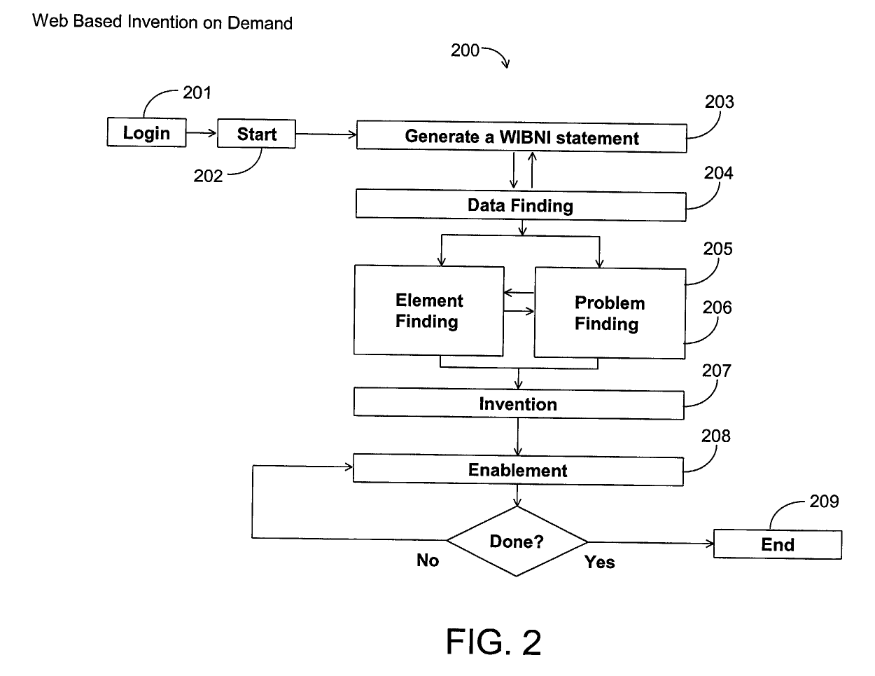

Referring now to the flowchart shown in FIG. 2, the IOD™ method of the invention can be summarized in the following steps:

1. Logging in 201;

2. Starting the process 202;

3. Generating a mess statement 203;

4. Generating data statements 204 relating to the mess statement, and optionally using the data statements refine the mess statement;

5. Generating problem statements 205 relating to the elements (step 6), data statements or mess statements;

6. Generating elements 206 relating to the problems, data statements or mess statements;

7. Conceiving one or more solutions 207 to the problems (the solutions are referred to below as a seeds of an invention);

8. Providing further enablement for the invention(s) 208; and

9. Ending the process 209.

Each of the foregoing steps is described in further detail in the ensuing sections.

### 7.1.1 Logging In

Like all computer processes, the method of the invention generally comprises a logging-in step. This step can be accomplished by any of the users (participant(s), facilitator(s) or owner(s)) or by support personnel. As an example, where the system of the invention is web-based, the logging in step will generally include the following sub-steps:

1. On a computer with internet access, using a web-browser or specialized interface to connect to the internet;

2. Accessing the network site of the IOD™ session, e.g., by accessing a website;

3. Entering a password or providing another form of identification; and

4. Entering the site.

An example of a suitable user interface screen 300 for logging into the IOD™ system is shown in FIG. 2. Title 301 identifies the network site. Instruction 302 directs the user to enter a password 303 into password field 304. Once the password 303 is entered, activating the “enter” button 305 will transmit the password to the server for validation.

The password validation process can suitably proceed as follows: the system accepts the password 303 as input and parses it to determine whether it is a valid password of a user and whether the user is a facilitator, participant or owner. Based on this determination, the system may display an output tailored to the role of the specific user. It will be appreciated that this function may also be accomplished using a userid, or any other means for identifying the identity and/or role of the user.

### 7.1.2 Initiating the IOD™ Process

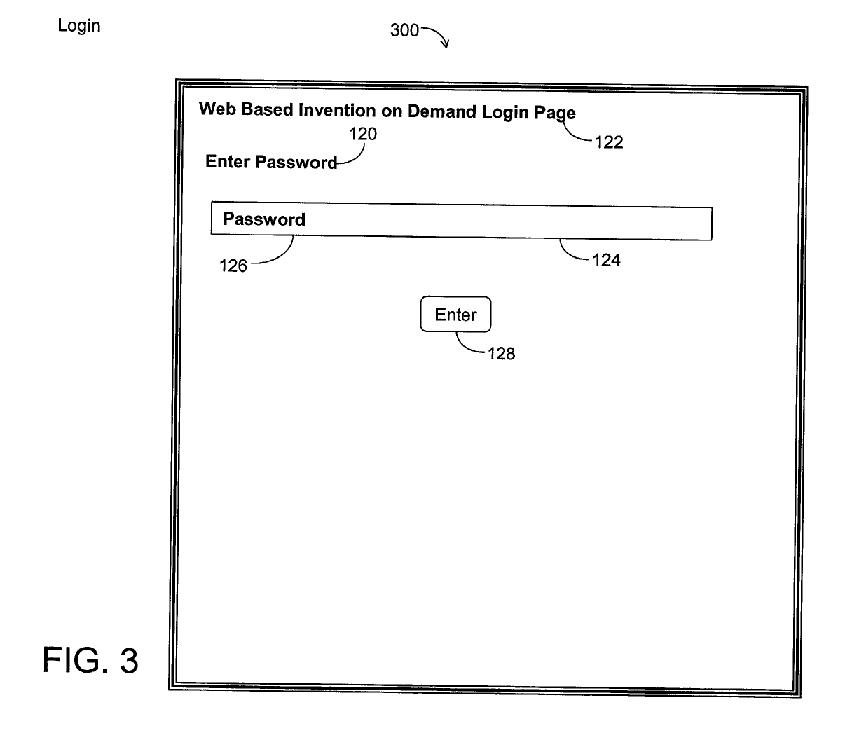

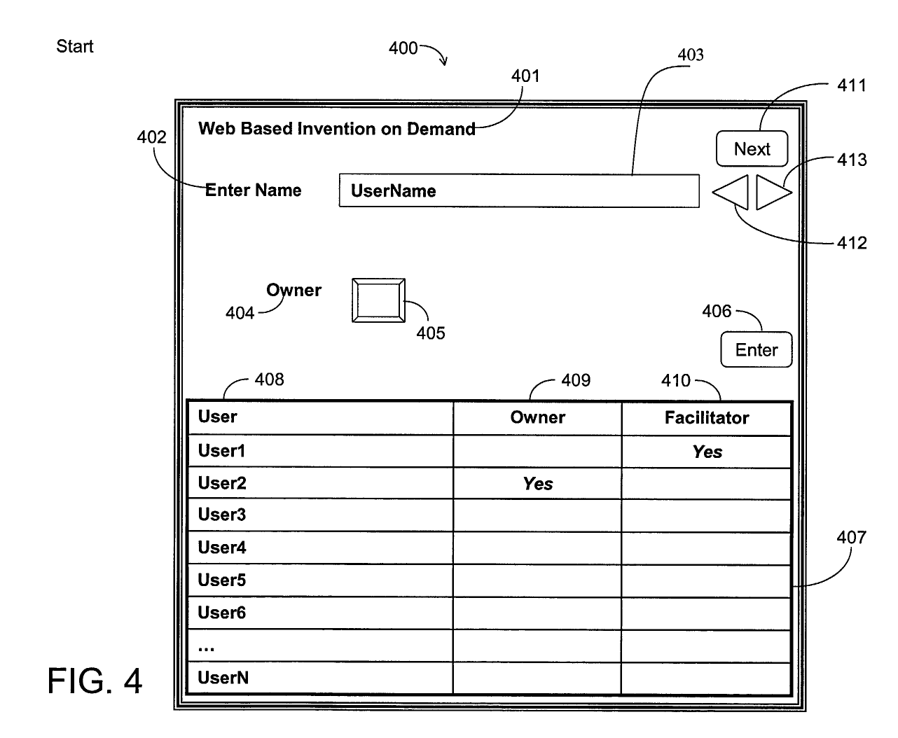

A user interface screen 400 suitable for use in initiating the IOD™ Process is shown in FIG. 4. Screen 400 includes a page title 401 and input fields for entry of information relating to the users. Instruction 402 requests the user to enter his or her name in name field 403. The screen may also include other fields, such as a “role” field (for identification of participant(s), facilitator(s), owner(s) and users playing multiple roles). In the embodiment shown in FIG. 3, the interface screen has an instruction 404 directing the user to activate the “owner” button 405 to indicate that the user is an owner. Other such fields or buttons can be used to indicate whether the user is a participant and or owner, or a combination of participant, facilitator and/or owner.

When a participant enters his or her name in name field 403 and activates “enter” button 406, the participant's name is transmitted to the server and stored in an electronic format, such as a database file or spreadsheet file. When an owner enters his or her name in name field 403, activates “owner” button 405, and activates “enter” button 406, the owner's name is transmitted to the server and stored in an electronic format, such as a database file or spreadsheet file. Likewise, the system may be programmed to permit a facilitator to enter his or her name in a manner analogous to the entry of a participant's name or an owner's name. It will be appreciated that information other than name may be entered in like manner. All such information from the users is preferably aggregated and stored in an electronic format, such as a database file or spreadsheet file. Moreover, all data entered by each user is preferably stored in a manner, which associates the data with such user.

The system is programmed to access the information stored in the foregoing steps and display output indicative of the information on the display units of the user interface computers and/or on a centralized display unit, preferably so that multiple or all users can view the aggregated information in a central location. In FIG. 4, the aggregated information is displayed in table form 407 on the user interface screen 400, with a user column 408, an owner column 409 and a facilitator column 410. Column 409 indicates that user 1 is a facilitator and user 2 is an owner. It will be appreciated that information can be displayed on the user interface screens of the invention in any of a wide variety of textual and graphical formats, such as flow charts, ven diagrams, and other formats. Moreover, color, special icons or other textual or graphical effects may be used to identify users, so that everything entered by the user is displayed in the identifying color or with an identifying icon or other textual or graphical identifier. Alternatively, some or all information may be displayed in a manner, which maintains the anonymity of the user.

The system is preferably programmed to permit a user to navigate between user interface screens. In the example shown in FIG. 4, this function is accomplished using a “next” button 411, a “back” button 412, and “forward” button 413. In the preferred embodiment, these buttons are present or active only for the facilitator, and are available on each of the screens except for the login screen 100. In this embodiment, when the facilitator activates one of the buttons, the screens of all participants change as directed. This arrangement permits the facilitator to navigate the participants through the steps IOD™ session, e.g., as shown in FIG. 2. For example, when the facilitator is satisfied that all users have entered their names the facilitator can click the next button to advance the IOD™ session to the mess statement-generating stage.

### 7.1.3 Generating a Mess Statement

A successful IOD™ session results in inventions that meet pre-defined criteria. The criteria are usually expressed using a positive, idealistic stem in the form of a mess statement. One such stem is “Wouldn't it be nice if . . . ” (WIBNI). The criteria for the generation of the mess statement may be set by agreement between a session facilitator and one or more participants or one with a proprietary interest in the results of the IOD™ session. As discussed in section 7.1.4 below, the mess statement-generating phase can interact with the data statement generating phase, and either may precede the other in the IOD™ session.

As an example, consider a hypothetical situation in which the Pick Up & Move Wheelbarrow Company has decided to enter a new market. Market research has revealed that an impending construction boom will lead to the construction of many skyscrapers. Presently available technology requires construction workers to carry the large bolts employed in high-rise construction in buckets by hand. Existing wheelbarrows are unsuitable because they cannot be manipulated conveniently on the steel girders of a skyscraper. Moreover, they are prone to tipping over, making them a severe safety hazard. Given this scenario, a mess statement that might be generated is: “Wouldn't it be nice if we had a wheelbarrow that was suitable for application in high-rise construction?”

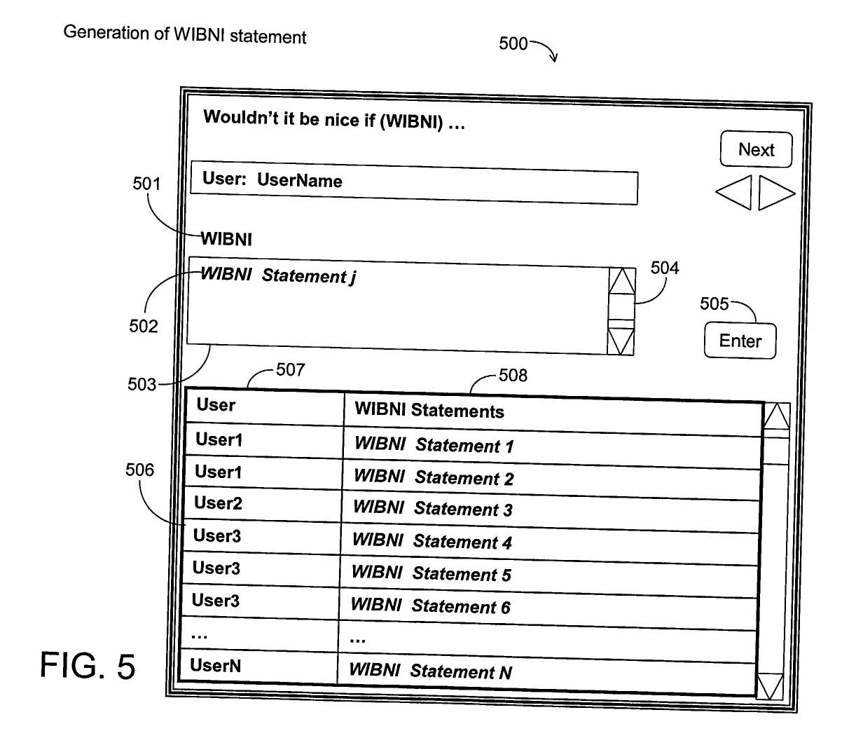

FIG. 5 shows a suitable user interface screen 500 for use in the mess statement generation step. Instruction or label 501 directs the user to type a WIBNI statement 502 into field 503. A scroll bar 504 or similar component may be used to facilitate viewing of longer WIBNI statements than can fit in the available space. A button or other component may be present to permit the user to transmit the WIBNI statement to the server for storage once it has been entered in the field. In the embodiment shown in FIG. 5, this function is accomplished using an enter button 505.

However, in this and other user interface screens, any means known in the art for such function may be used, e.g., pressing a key on a keyboard, such as the “enter” key.

At the server, the WIBNI is aggregated with other WIBNIs and stored in a manner which permits the data to be accessed and displayed on the user interface computers or on a centrally viewable display unit. Preferably most or all proposed WIBNI statements are displayed in a manner which makes them viewable by all participants, so that the participants can benefit from fellowparticipants' WIBNIs. In the embodiment shown in FIG. 5, the WIBNI statements are displayed in table 506 with a user column 507 and a WIBNI column 508. As noted above, in this and other user interface screens, entries by each participant can be identified by color, icons, or other graphical identifiers.

The determination that sufficient WIBNIs have been generated can be made in a variety if ways. For example, the determination may be made by the facilitator; by one with a proprietary interest in the results of the IOD™ session; and/or by one or more of the participants. Alternatively, the WIBNI-generating step may end when a predetermined number of ideas is reached; the system may be programmed to automatically proceed to the next phase when a triggering event is satisfied.

Notably, the method of the invention facilitates the use of a long-term IOD™ process in which the session can continue for days, months, or even years. Users can log onto the system at various steps of the process when they are prepared to contribute a WIBNI or other input. Moreover, the system can be programmed to generate emails or other notifications to users notifying them of the input of a new WIBNI or other information about the IOD™ process, such as when a stage in the process is complete. The WIBNI-generating stage of a long-term IOD™ process may be complete when a predetermined number of WIBNI statements are entered or when a facilitator or owner, who is monitoring the session (e.g., via emails or accessing the site) determines that a sufficient number of WIBNI statements have been generated.

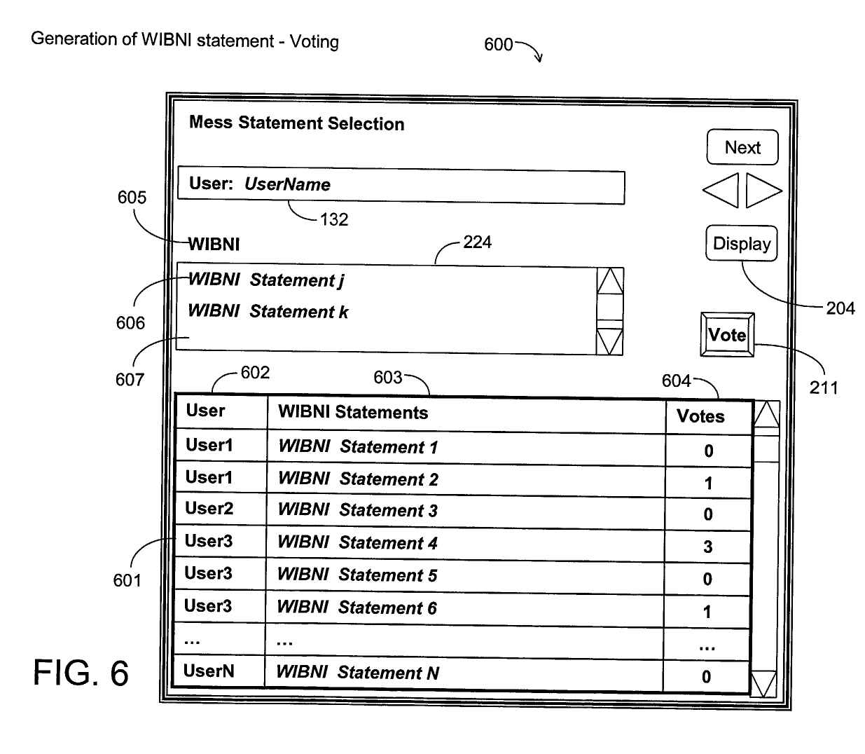

Following the WIBNI-generating stage, the users, especially the participants, will preferably have an opportunity to vote on the WIBINI statements. FIG. 6 shows simple user interface 600 for permitting users to vote on WIBNI statements. The purpose of the interface is to permit voting on processes to permit selection of a specific mess statement to use for the IOD™ process. In this embodiment, a table 601 is displayed on the user interface screen 600. However, it will be appreciated that, in this and other user interface screens, the table may be displayed only on a centrally viewable display unit, or on both the user interface screen and a centrally viewable display unit. Moreover the table may be replaced with or supplemented by other textual and/or graphical display types, which convey the same or similar information. In the embodiment illustrated by screen 600, the table includes a user column 602, a WIBNI statement column 603 and a vote column 604. In some circumstances, it may be useful to omit the user column 602 to make the WIBNI statements anonymous. When the screen first appears, the tally of votes for each WIBNI statement in the vote column 604 is set to zero. Label 605 indicates that the user is to enter a preferred WIBNI statement 608 in field 609. Entry of a preferred WIBNI statement transmits vote data to the server. The vote data is aggregated, stored and calculated to provide an output. The output may simply be the leading WIBNI statement, or the output may be a list of WIBNI statements as shown in table 601, with the total number of votes for each WIBNI statement being displayed in column 604. Again, the output may be displayed on a central screen, the user interface computers or both. In a long-term IOD™ process, the results of the vote may be emailed to the users, preferably with a message indicating that the next stage in the IOD™ session has begun, and may also include an embedded form for submission of notes by the user.

Voting can be accomplished according to any of the many known systems for voting. For example, a participant can be given a limited number of votes and permitted to select one WIBNI statement with each vote. In other systems, participants may provide additional weight to their vote by using more than one vote on a single WIBNI statement. As another alternative, participants may be asked to rank each WIBNI statement, and the system can be configured to rank all WIBNI statements based on the individual rankings. The system may be programmed to permit the facilitator or owner to override the results of the votes or to give extra weight to the votes of one or more users. Additionally, users may be asked to vote or rank more than one attribute of the WIBNI statement.

Results of voting can be displayed in any of a number of graphical or textual formats. For example, each WIBNI statement may be represented as a bar on a bar graph, with the height of the bar representing the number of votes or the ranking of the statement. The bars may grow in real time as the users enter their votes. Other types of graphs or charts may be used to display the output of the vote. Three-dimensional graphs may be used for votes involving multiple attributes. As another example, WIBNI statements may be placed in order from the statement receiving the highest vote to the statement receiving the lowest vote. Printed output may be created for future reference.

Following the voting, the facilitator may provide input to the system, instructing the system to proceed to the next phase of the IOD™ method, in which a mess statement selected by the voting process or by the owner or facilitator will be used in the data finding phase.

### 7.1.4 Data Generating

In the data-generating stage, the user(s) generate data statements relating to the mess statement and/or statements relating to a target market, target technology area and the like. Note that, as shown in FIG. 2, the mess statement-generating and data-generating phases of the invention can interrelate. Either can come first in the overall process, and either can be used as creative stimulus to generate the other. For example, the user(s) can generate a mess statement, followed by data statements relating to the mess statement.

The data generating activity may serve as creative stimulus leading the user(s) to conceive of modifications to the mess statement. Alternatively, the process may begin with data finding. For example, if the goal of the IOD™ session is to invent in a particular market space or technology area, the user(s) may begin by listing information about the market space. Data accumulated during a data generating phase is technical or business information relating to the mess statement or to a specific technology or market area. The goal of the data is to catalogue business and/or technology aspects of the technology and/or market, e.g., to paint a picture of the state of the art. As described below, the data statements will be used as stimulus to facilitate conception by the users of elements and problem statements.

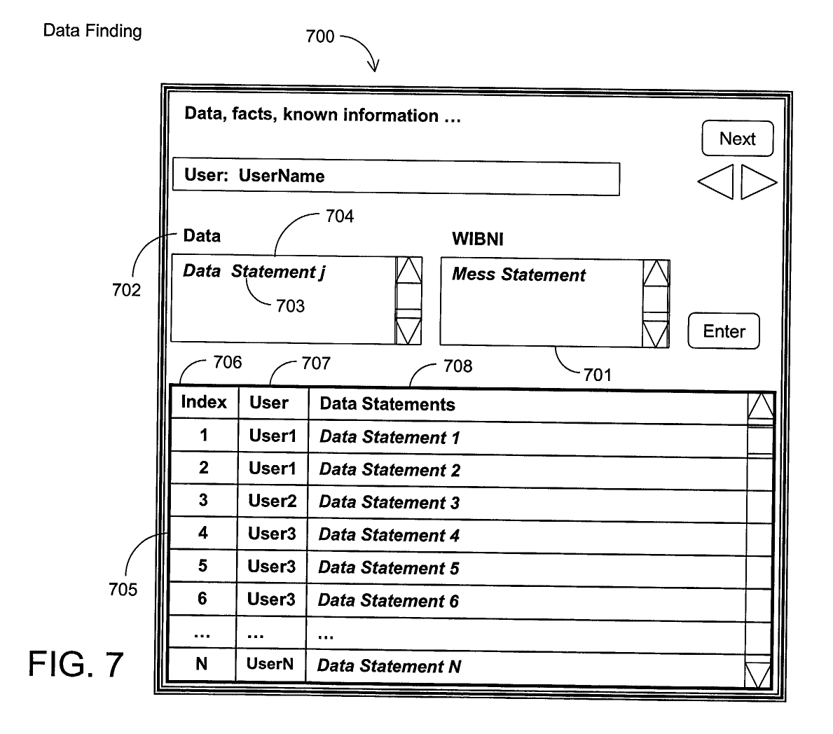

A user interface screen 700 suitable for use in the data finding stage of the IOD™ process is shown in FIG. 7. The screen 700 displays the preferred mess statement selected by the voting process or by the owner or facilitator, e.g., in a display box 701. Instruction or label 702 directs the user to enter a data statement 703 into data statement field 704. The data statement is a textual description of data pertaining to the preferred mess statement 702. The system is programmed to permit the user to transmit such data statements to the server, where data statements from all users are aggregated and stored, e.g., in a data file, such as a database of a spreadsheet file.

The system is preferably configured to provide output displaying the data statements in a format viewable by the users, either on the user interface computers or on a central display unit or both. In a long-term IOD™ application, each data statement may be emailed to the users after it is input. The email may contain the new data statement alone or in combination with all previously entered data statements. The email may contain an embedded link, which permits the user to access the website to enter further data statements, which may be conceived as a result of reading the email with the new data statement. Alternatively, or conditionally, the email may contain an embedded form to permit the user to submit additional data statements. In the output embodiment shown in FIG. 7, a table 705 contains an index column 706, a user name column 709, a data statement column 708.

When sufficient data statements have been generated, the facilitator advances the IOD™ process to the problem-generating stage.

A determination that sufficient data statements have been generated can be made in a variety if ways. For example, the determination may be made by the facilitator; by one with a proprietary interest in the results of the IOD™ session; and/or by one or more of the participants. Alternatively, the data statement-generating step may end when a predetermined number of ideas have been entered. Here, as in other stages of the IOD™ process, the system may be programmed to automatically advance to the next phase when such a predetermined threshold is reached.

### 7.1.5 Generating a Problem Statements

In this phase of the IOD™ session, user(s) use the miscellaneous facts, data, and relevant attributes pertaining to the mess statement (i.e., the data statements) and the mess statement as stimuli to identify problem statements. In other words, the user(s) now have a goal (as represented by the mess statement), and a picture of the state of the art (as represented by the data statements); the participants can now generate problem statements by indicating problems in the state of the art which appear participant(s) to prevent or hinder the attaimnent of the goal. Problem statements are suitably phrased in the form of “How to . . . ” (H2) statements.

As an example, in an IOD™ session in which the goal is to develop a new cup, a list of problem statements might be generated as follows: H2 keep fluids warm longer? H2 insure cups do not tip? H2 not loose cups? H2 not overfill cups? H2 have cup easily washable?

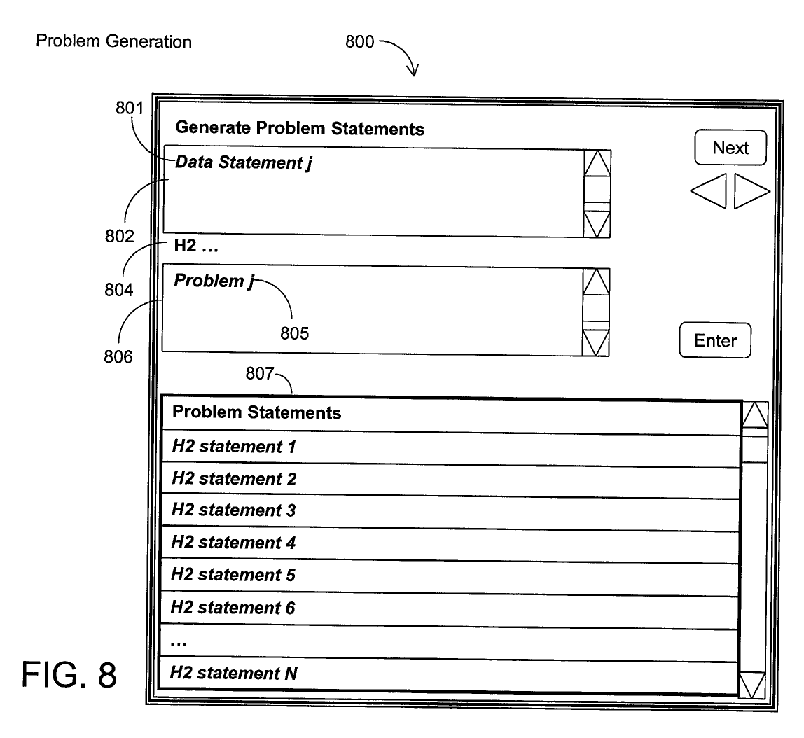

FIG. 8 shows an exemplary embodiment of a user interface screen 800 for the problem statement generating aspect of the invention. The data statements 801 appear in display box 802, preferably without indication of authorship. As in other user interface screens, a component, such as scroll bar 803 may be present to permit the user to view all contents of a display box or other field. Alternatively or additionally, use of arrow keys, a mouse or other known means for scrolling may be used to perform this function in the user interface screens.

Instruction or label 804 indicates that problem statements 805 are to be entered in field 806, preferably in the form of “how to” (H2) statements. The system is programmed to permit the user to transmit the H2 statements to the server where they are stored and aggregated in a data file, such as a database file or a spreadsheet file. In one embodiment of the invention each problem statement is associated with a specific data statement or element.

The system is also programmed to display the aggregated problem statements on the display units of the user interface computers, on a centralized display unit, or both. In a long-term IOD™ application, each problem statement may be emailed to the users after it is entered. The email may contain the new problem statement alone or in combination with all previously entered problem statements and/or other information pertaining to the status of the IOD™ process. The email may contain an embedded link, which permits the user to access the website to enter further data statements, which may be conceived as a result of reading the email with the new data statement. Alternatively, or additionally, an embedded form may be used for this purpose. In the embodiment exemplified in FIG. 8, the problem statements are displayed in list 807.

As in other phases of the IOD™ session, a determination that sufficient problem statements have been generated can be made in a variety if ways. For example, the determination may be made by the facilitator; by one with a proprietary interest in the results of the IOD™ session; and/or by one or more of the participants. Alternatively, the data statement-generating step may end when a predetermined number of ideas have been entered. When the determination that sufficient problem statements have been generated is made, the facilitator advances the IOD™ session to the element-generating phase. Alternatively, the system may be programmed to automatically advance the session when a predetermined number of statements are entered.

### 7.1.6 Generating Elements

In this phase the user(s) generate a list of elements relating to a solution to the mess statement. These elements are similar to the data generated in the data-generating phase; however, the information generated in the data-generating phase relates to the state of the technology and/or business area that form the setting for the mess statement, while the information generated in the element-generating phase can include facts, data, etc., which relate to a potential answer to the mess statement. Moreover, the elements serve an important creativity-stimulating role, and as such they may be items not related to the invention at all. For example, the elements may be attributes of a picture or object given to the participants by the facilitator, they may be randomly generated and/or they may be supplied by the facilitator. For example, given a fern as an object to stimulate the conception of elements, the users may generate the following elements: green, self-generating, uniform components, energy-efficient, flexible, seasonal, etc. The element and problem may occur simultaneously or in any order relative to the other, and either may use the other as a creativity stimulus, i.e., to facilitates conception of the other generating phases.

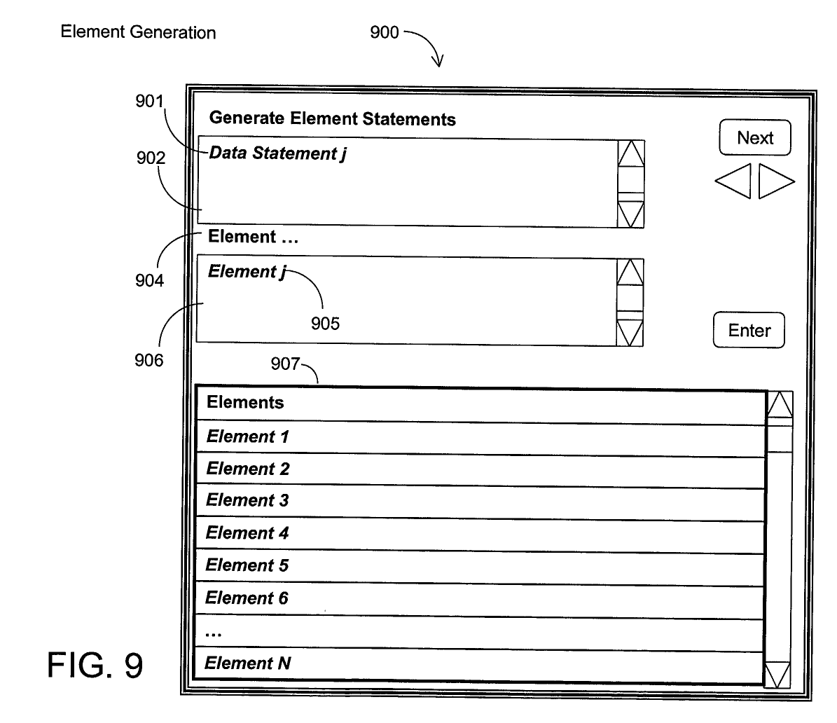

FIG. 9 shows an exemplary embodiment of a user interface screen 900 for use in the element-generating phase of the IOD™ process. The data statements 901 appear in display box 902, preferably without indication of authorship. Instruction or label 904 indicates that elements 905 are to be entered into data field 906. The user selects a specific data statement 901 and enters a corresponding element relating to the data statement. The user then transmits the element to the server, which aggregates and stores in a data file (e.g., a database file or spreadsheet file) the elements and the relationship of each element to a data statement.

The system is also programmed to display the aggregated elements on the display units of the user interface computers, on a centralized display unit, or both. In a long-term IOD™ application, each element may be emailed to the users after it is entered. The email may contain the new element alone or in combination with all previously entered problem elements and/or other information pertaining to the status of the IOD™ process. The email may contain an embedded link or form, which permits the user to submit further elements, which may be conceived by a user as a result of reading the email with the new element. In the embodiment exemplified in FIG. 9, the elements are displayed in list 907. Users can use a scroll bar 903 to view all of the entered problem statements; however, it will be appreciated that the elements may be displayed in any variety of ways.

A determination that sufficient elements have been generated can be made in a variety if ways. For example, the determination may be made by the facilitator; by one with a proprietary interest in the results of the IOD™ session; and/or by one or more of the participants. Alternatively, the element-generating step may end when a predetermined number of elements have been entered. As in other phases of the IOD™ process, when sufficient problem statements have been generated, the IOD™ session is advanced to the solution-generating phase, e.g., by the facilitator or the system.

### 7.1.7 Conceiving of Solutions or Seeds of Invention (SOI)

In this phase of the IOD™ process, elements are associated with problem statements, and the association is used as a creative stimulus to facilitate conception of solutions or seeds of invention. The association of elements to problem statements may be random, or may be selected by the facilitator, or may be selected by individual users.

The selection of problem statement and element is preferably done at least three times. During the first period of invention, the participants are asked to pick their own problem and element. The novelty of invention during this period is generally low. During the second period of invention, the participants are asked to pick a problem and element pair for someone else. The novelty of invention during this period is generally moderate to high. During the third period of invention, the participants are asked to pick a problem and element pair at random. The novelty of invention during this period is generally high.

As an example, association of “H2 keep fluids warm longer?” and element “tuning” might generate an SOI “Heat cup using RF energy (tuning).”

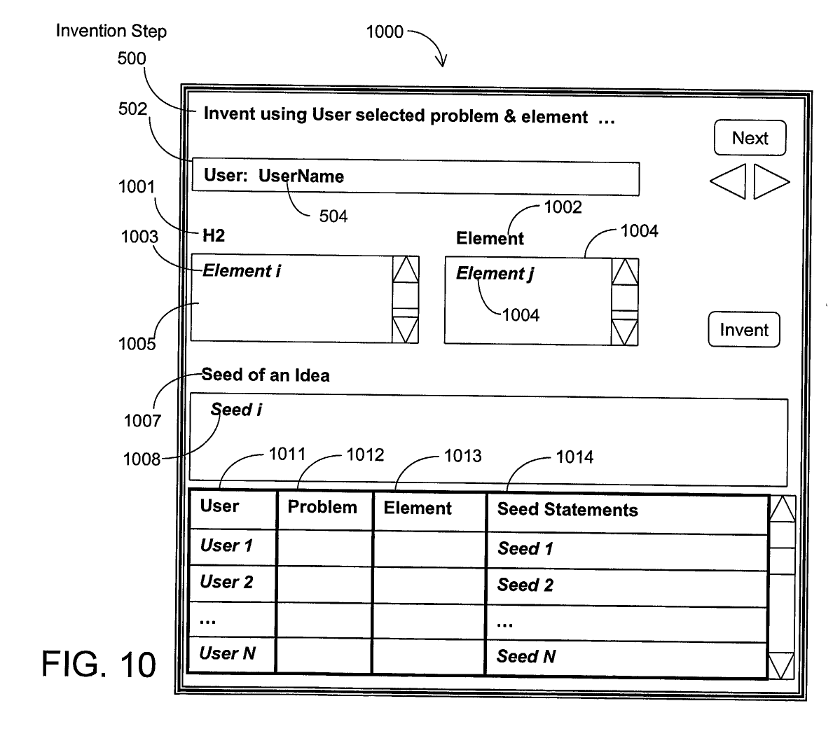

FIG. 10 shows an exemplary user interface display 1000 for use in one embodiment of the solution-finding stage of an IOD™ session. Labels or instructions 1001 and 1002 direct the user to select a specific problem statement 1003 and a specific element 504. The user scrolls through problem display box 1005 and element display box 1006 to visually identify and select the problem statement 1003 and element 1004. It will be appreciated that the selection of a problem statement and element can be accomplished by any number of techniques known in the art for selecting from a variety of options displayed on a computer screen, e.g., point-and-click methods, check box methods, drop and drag methods, drop-down menus, etc. The user then uses the problem and element selected as creative stimuli to facilitate conception of an SOI. The SOI is then recorded in the system. For example, in FIG. 10, label or instruction 1007 instructs the user to enter the SOI 1008 in text field 1009. The SOI is then transmitted to the server, with an indicator of its relationship to the selected problem statement 1003 and the selected element 1004. The system may alternatively or additionally, randomly match H2 statements and elements for use by the user as creative stimulus in developing a seed of an idea. Moreover, the system may email H2/element combinations, e.g., randomly select or selected by a facilitator, to users for use in facilitating conception of SOIs.

The system is also programmed to display the aggregated SOI statements, especially with an indicator of their relationship to a SOI, on the display units of the user interface computers, on a centralized display unit, or both. In a long-term IOD™ application, each SOI may be emailed to the users after it is entered. The email may contain the new SOI alone or in combination with all previously entered SOIs, other information pertaining relationship of the SOI to problem statements and elements, and/or information relating generally to the status of the IOD™ process. The email may contain an embedded link, which permits the user to access the website to enter further SOI statements, which may be conceived by a user as a result of reading the email with the new SOI statement. In the embodiment exemplified in FIG. 10, the SOI statements are displayed in a table 1010, which displays a user column 1011, a problem column 1012, an element column 1013 and a SOI column 1014.

A determination that sufficient SOI statements have been generated can be made in a variety if ways. For example, the determination may be made by the facilitator; by one with a proprietary interest in the results of the IOD™ session; and/or by one or more of the participants. Alternatively, the SOI-generating step may end when a predetermined number of SOI statements have been entered. When sufficient SOI statements have been generated, IOD™ session is advanced (e.g., by a facilitator or automatically) to the solution-generating phase.

### 7.1.8 Enabling the Invention(s)

In the enabling phase of the IOD™ process, users identify technical problems which prevent or hinder the accomplishment of the SOI and conceive of solutions to the technical problems.

For example, with reference to the cup-heating example above, a participant might raise the question, “How would you heat the cup using RF energy?” This question becomes a problem statement. The user who posed the problem or another user might conceive of a solution to the problem statement, involving the additional element of a coil. Another participant might then identify another problem: “How exactly should the coil be used.” The posing of this subordinate problem might prompt another participant to think of a solution; the addition of a base in which to put the coil.

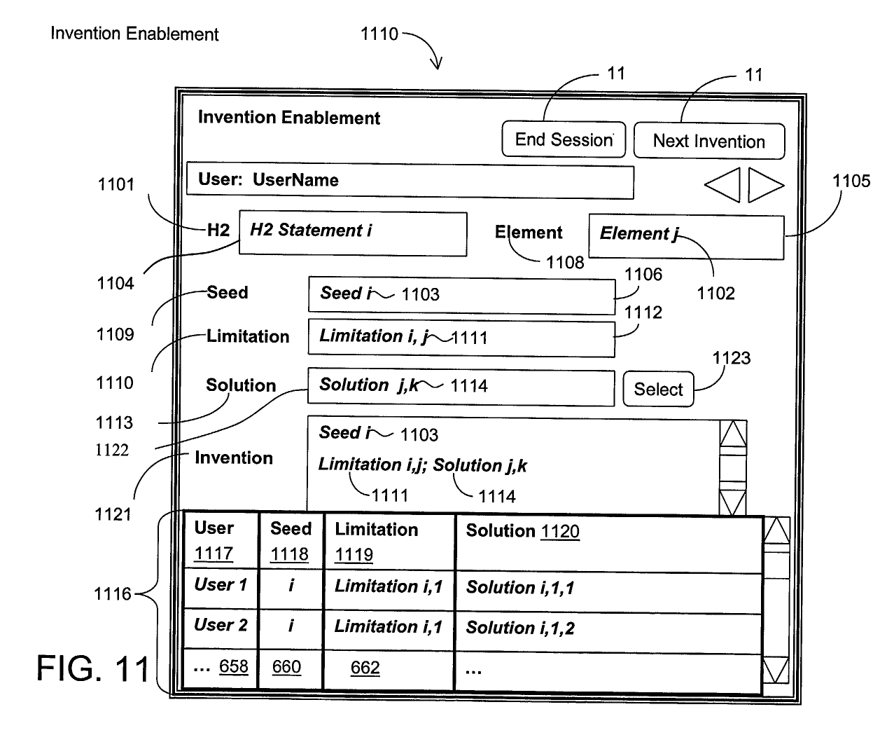

FIG. 11 shows an example of an enablement screen 1100 suitable for use in the enabling phase of an IOD™ session. A specific problem statement 1101, element 1102 and SOI 1103 are displayed; each is displayed in a field 1104, 1105 and 1106, respectively, with an associated label, 1107, 1108 and 1109, respectively. The displayed problem statement 1101, element 1102 and SOI 1103 are used as creative stimuli to facilitate conception of inventive subject matter.

Label or instruction 1110 directs the user to identify a limitation of the invention, i.e., a reason why the invention might not work or a partial or complete constraint on its operation. The limitation 1111 is then entered in field 1112. Label 1113 directs the user to enter a proposed solution 1114 to the limitation in field 1115. The user then transmits the entered data, e.g., by pressing the select button 1123, to the server for storage in a data file, such as a database file or a spreadsheet file. The data is preferably stored with an indicator that the problem statement, element, limitation and solution are related.

In the embodiment shown in FIG. 11, this data is then displayed in table 1116, with a user column, 1117, a SOI column, 1118, a limitation column, 1119 and a solution column 1120.

An IOD™ invention is defined as the SOI 1103 plus all limitations to the SOI 1103 plus all solutions to the limitations. In the embodiment shown in FIG. 11, the IOD™ invention is displayed next to label 1121, in field 1122. An IODTM inventive concept is the seed of an idea plus some or all of the limitations that would render the invention inoperable, without a complete set of solutions to the limitations. While an inventive concept is not a potentially patentable idea, it is nevertheless a valuable asset, since problems not identified or overcome during the IOD™ session may be overcome at a later date, e.g., in a subsequent IOD™ session or in an extended IOD™ session.

The users preferably work in parallel on each seed of an idea, identifying limitations and solutions to limitations, in a collective enablement effort. Moreover, each user preferably has an opportunity to identify solutions to limitations conceived by other users. As the IOD™ inventions for each SOI are exhausted, the facilitator advances to the next SOI until all SOIs are exhausted.

A determination that sufficient IOD™ inventions have been generated for each SOI can be made in a number of ways. For example, the determination may be made by the facilitator; by one with a proprietary interest in the results of the IOD™ session; and/or by one or more of the participants. Alternatively, the facilitator may advance to the next SOI when a predetermined number of IOD™ inventions have been entered for the current SOI, or when a predetermined period of time elapses without the identification of a new problem or a new solution for the current SOI. When the determination is made that sufficient IOD™ inventions and/or IOD™ inventive concepts have been generated for each seed of an idea, the facilitator ends the IOD™ session.

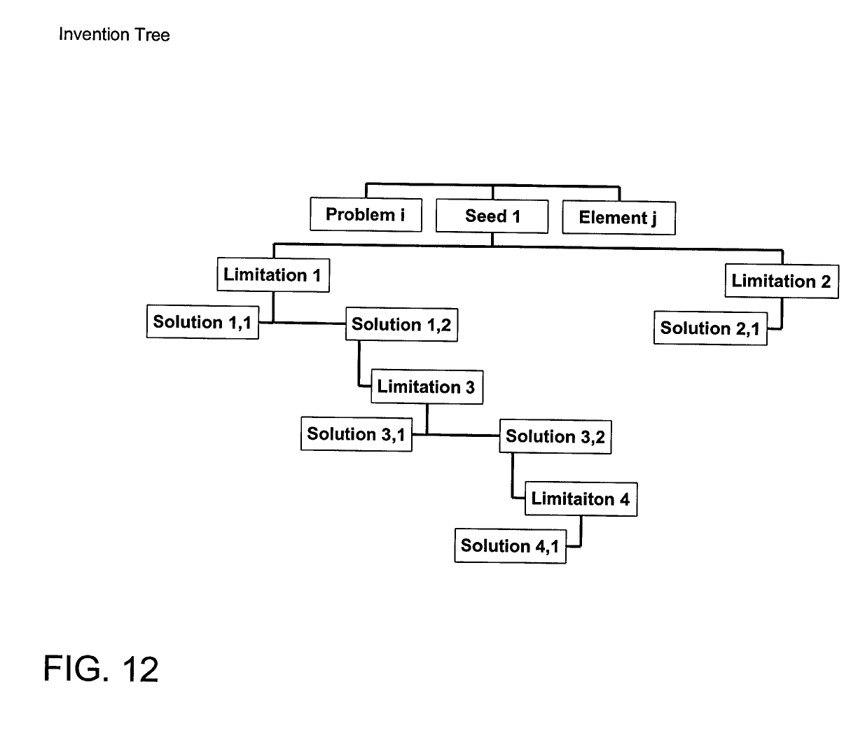

The result of the IOD™ invention-generating process is a map of each IOD™ invention, showing all limitations and solutions. As noted above, an IOD™ invention is complete when there is at least one solution to each problem. FIG. 12 shows an example of how an IOD™ invention might be mapped as a flow chart 1200. Problem i and element j lead to seed of an invention 1. In this example, two limitations are identified, limitation 1 and limitation 2. Solutions 1,1 and 1,2 address limitation 1. Solution 2,1 is addresses limitation 2. No further limitations are found with solution 1,1; however, a limitation 716 is conceived to solution 1,2. In this example, solution 3,1 and solution 3,2 address limitation 3. Solution 3,1 has no further limitations, but solution 3,2 has yet another limitation 4. Solution 4,1 is conceived to address limitation 4. Since no unsolved limitations are identified, the flow chart represents a complete IOD™ invention.

An invention that has been mapped in this manner is presumed to be potentially enabled according to legal requirements of patent law, since all problems conceived by a group of users skilled in the technology of the invention have been addressed. However, it is noted that a legal determination of enablement involves an application of legal concepts to claim language, and since the mapped IOD™ invention does not constitute a claim, this legal determination cannot be made at this point in the IOD™ process. Nevertheless, the mapped IOD™ invention provides a concise description of the IOD™ invention, which can serve as the basis for the preparation of an invention disclosure document, a provisional patent application, a utility patent application, or the like. Moreover, the mapped IOD™ invention provides a concise document for use in subsequent interviews of the inventors or other technical or business experts to assist in the completion of a detailed description of the invention and/or to facilitate further evaluation of the business and technical prospects for the invention.

### 7.1.9 Ending the Process

When all of the inventions have been mapped to enablement, or when a determination is made that that the session is complete, the facilitator ends the session, e.g., by pressing an “end session” button or by other means for exiting a program. The system preferably also includes a means for saving and exiting the system while the IOD™ session is in progress, so that completion of the session can be postponed.

### 7.2 Data Input and Output

The user interface display screens shown in FIGS. 3-11 are exemplary of a simple embodiment of the invention. It will be appreciated that the functions of these screens may be replicated using a wide variety of alternative embodiments. For example, alternative embodiments may utilize various data entry fields, scroll bars, menu bars, pull-down menus, action buttons, etc. Calculation and execution commands are performed in any of a variety of code types, e.g. VBSCRIPT or JAVASCRIPT. The database manipulations can be accomplished using a language, such as SEQUEL.

### 7.3 Conclusion

In addition to the features and advantages of the invention explicitly detailed herein, numerous modifications and changes will readily occur to those of ordinary skill in the art upon review of this disclosure. The invention should be understood to include all such limitations. Accordingly, all suitable modifications and equivalents should be considered as falling within the spirit and scope of the invention.

What is claimed is:

1. A system for facilitating conception of inventions in a directed manner comprising a computer processor programmed to execute the following functions:
(a) requesting and accepting input comprising data selected from the group consisting of:
(i) mess statements;
(ii) data statements relating to the mess statements;
(iii) problem statements relating to the data statements;
(iv) elements relating to the problem statements, mess statements and/or data statements;
(v) solutions to the problem statements;
(vi) limitations of problem-element-solution combinations; and
(vii) solutions to the limitations;
(b) aggregating and storing said input data; and
(c) providing output displaying aggregated input data of (a)(i) to (a)(vii).

2. The system of claim 1 wherein the input data comprises one or more mess statements.

3. The system of claim 2 wherein the input data comprises one or more data statements relating to the mess statements.

4. The system of claim 3 wherein the input data comprises one or more problem statements relating to the data statements, elements and/or mess statements.

5. The system of claim 4 wherein the input data comprises one or more elements relating to the problem statements, mess statements and/or data statements, or where the elements are randomly generated or are conceived by the users as the result of a stimulus.

6. The system of claim 5 wherein the elements are randomly generated.

7. The system of claim 5 wherein the elements are conceived using a visual, tactile or olfactory stimulus.

8. The system of claim 5 wherein the input data comprises one or more solutions to the problem statements.

9. The system of claim 8 wherein one or more of the solutions is conceived using one element and a problem statement as creative stimulus, and the solution is stored in a manner which indicates its relationship to a problem and an element.

10. The system of claim 8 wherein the input data comprises one or more limitations of problem-element-solution combinations.

11. The system of claim 10 wherein the input data comprises one or more solutions to the limitations.

12. The system of claim 1 wherein the system instructs the user that a complete invention comprises:
(a) a seed of an invention;
(b) all limitations of the seed of an invention; and
(c) all solutions to the limitations.

13. The system of claim 1 wherein the computer processor is a component of a server.

14. The system of claim 13 further comprising one or more participant computers operably linked to the server.

15. The system of claim 14 wherein one or more of the participant computer(s) is linked via a network system selected from the group consisting of: local area networks, virtual private networks, an near private networks, the Internet, an intranet.

16. The system of claim 14 wherein:
(a) one or more of the participant computers is remotely located relative to the server; and/or
(b) one or more of the participant computers is remotely located relative to on or more other participant computers.

17. A method for facilitating conception of inventions in a directed manner, the method comprising:
(a) providing a computer processor programmed to accept input and provide output;
(b) inputting data selected from the group consisting of:
(i) mess statements;
(ii) data statements relating to the mess statements;
(iii) problem statements relating to the data statements;
(iv) elements relating to the problem statements, mess statements and/or data statements;
(v) solutions to the problem statements;
(vi) limitations of problem-element-solution combinations; and
(vii) solutions to the limitations;
(c) aggregating and storing the data input in step (b);
(d) providing output displaying aggregated input data of (b)(i) to (b)(vii).

18. The method of claim 17 further comprising facilitating the conception by one or more participants of any one or more types of information selected from the group consisting of:
(a) mess statements;
(b) data statements relating to the mess statements;
(c) problem statements relating to the data statements;
(d) elements relating to the problem statements, mess statements and/or data statements;
(e) solutions to the problem statements;
(f) limitations of problem-element-solution combinations; and
(g) solutions to the limitations.

19. The method of claim 18 further comprising using a problem statement and an element as creative stimuli to facilitate conception of a solution to the problem statement.

20. The method of claim 18 further comprising identifying on or more limitations of a problem-element-solution combination and solutions to the limitation.

21. The method of claim 17 further comprising using problem-element combinations as creative stimuli to facilitate inventive conception.

22. The method of claim 17 wherein the input data comprises elements (b)(i)-(b)(vii).

23. The method of claim 17 further comprising communicating via a telephone system, the telephone system having conference calling capabilities.

24. The method of claim 17 wherein the computer processor is a component of a server.

25. The method of claim 24 further comprising one or more participant computers operably linked to the server.

26. The method of claim 25 wherein one or more of the participant computer(s) is linked via a network system selected from the group consisting of: local area networks, virtual private networks, an near private networks, the Internet, an intranet.

27. The method of claim 25 wherein:
(a) one or more of the participant computers is remotely located relative to the server; and/or
(b) one or more of the participant computers is remotely located relative to one or more other participant computers.
